(19) United States
(12) Patent Application Publication
(10) Pub. No.: US 2026/0077681 A1
(43) Pub. Date: Mar. 19, 2026

(54) POWER SUPPLY SYSTEM

(71) Applicant: TOYOTA JIDOSHA KABUSHIKI KAISHA, Toyota-shi (JP)

(72) Inventor: Yohei HOSOKAWA, Susono-shi (JP)

(73) Assignee: TOYOTA JIDOSHA KABUSHIKI KAISHA, Toyota-shi (JP)

(21) Appl. No.: 19/250,732

(22) Filed: Jun. 26, 2025

(30) Foreign Application Priority Data
Sep. 18, 2024 (JP) 2024-160828

(51) Int. Cl. B60L 58/22; B60L 15/00; B60L 53/24; B60L 58/19

(52) U.S. Cl. CPC B60L 58/22; B60L 15/007; B60L 53/24; B60L 58/19

(57) ABSTRACT

The power supply system includes a first battery, a second battery, a voltage converter connected to a power generation device or an external power supply, and a series-parallel switching circuit that is switchable between a series connection of the first battery and the second battery and a parallel connection of the first battery and the second battery by turning on and off a plurality of relays. The power supply system executes charge equalization control in which first battery charge process of turning on and off the relays to charge solely the first battery and state-of-charge equalization process of equalizing a state of charge ratio of the first battery and a state of charge ratio of the second battery are alternately performed.

### CROSS-REFERENCE TO RELATED APPLICATION

This application claims priority to Japanese Patent Application No. 2024-160828 filed on Sep. 18, 2024. The disclosure of the above-identified application, including the specification, drawings, and claims, is incorporated by reference herein in its entirety.

### BACKGROUND

### 1. Technical Field

The present disclosure relates to a power supply system, and more particularly, to a power supply system for a vehicle installation including two batteries that can be charged and discharged by being connected in series and charged and discharged by being connected in parallel.

### 2. Description of Related Art

As this kind of power supply system, a series-parallel battery system capable of switching a plurality of batteries between a series connection and a parallel connection has been proposed (for example, see Japanese Unexamined Patent Application Publication No. 2013-081316 (JP 2013-081316 A)). In the system, the connection method at the time of start of charging is selected based on a temperature and an SOC of the power supply device, and the charging current for a parallel connection method is controlled using an upper limit value that is larger than an upper limit value of the charging current for a series connection method input to the power supply device.

### SUMMARY

As a method of charging the two batteries, the following methods can be considered. For example, a method of connecting two batteries in series to charge the two batteries at the same time can be considered. For example, a method of connecting two batteries in parallel to charge the two batteries at the same time can be considered. For example, a method of alternately connecting two batteries to a power supply to alternately charge the two batteries can be considered. In the method of connecting two batteries in series to charge the two batteries at the same time, a power supply voltage needs to be increased. In the method of connecting two batteries in parallel to charge the two batteries, a power supply current needs to be increased. In the method of alternately charging the two batteries, in a case where a loss in a circuit for charging the first battery is different from a loss in a circuit for charging the second battery, a charging efficiency is reduced.

A main object of the power supply system according to the present disclosure is to improve the efficiency in charging two batteries that can be connected in series and in parallel by using electric power from a power generation device installed in a vehicle or an external power supply.

In order to achieve the above-mentioned main object, the power supply system according to the present disclosure is configured as follows.

A power supply system according to the present disclosure includes:
a first battery;
a second battery having the same configuration as the first battery;
a power converter connected to either or both of a power generation device installed in a vehicle and an external power supply;
a series-parallel switching circuit including a plurality of relays and being switchable between a series connection of the first battery and the second battery and a parallel connection of the first battery and the second battery by turning on and off the relays; and
a control device configured to control and drive the relays of the series-parallel switching circuit, and
the control device performs, when the first battery and the second battery are charged by electric power from the power generation device or the external power supply, charge equalization control of alternately performing, a first battery charge process of charging solely the first battery by turning on and off the relays such that solely the first battery is charged by the electric power from the power generation device or the external power supply, and a state-of-charge equalization process of equalizing a state of charge of the first battery and a state of charge of the second battery by charging the second battery by electric power from the first battery by turning on and off the relays such that the second battery is charged by the electric power from the first battery.

The power supply system according to the present disclosure is installed in a vehicle and includes:
a first battery;
a second battery having the same configuration as the first battery;
a power converter connected to a power generation device installed in a vehicle or an external power supply;
a series-parallel switching circuit including a plurality of relays and being switchable between a series connection of the first battery and the second battery and a parallel connection of the first battery and the second battery by turning on and off the relays; and
a control device configured to control and drive the relays of the series-parallel switching circuit.

The control device performs, when the first battery and the second battery are charged by electric power from the power generation device or the external power supply, charge equalization control of alternately performing, a first battery charge process of charging solely the first battery by turning on and off the relays such that solely the first battery is charged by the electric power from the power generation device or the external power supply, and a state-of-charge equalization process of equalizing a state of charge of the first battery and a state of charge of the second battery by charging the second battery by electric power from the first battery by turning on and off the relays such that the second battery is charged by the electric power from the first battery. The equalization of the state of charge of the first battery and the state of charge of the second battery is performed in a relatively short period of time. Therefore, it is possible to charge both the first battery and the second battery in a short equalization time in addition to the time for solely charging the first battery by the electric power from the power generation device or the external power supply, thereby improving charging efficiency. In particular, when a loss in a circuit for charging the second battery with electric power from the power generation device or the external power supply is greater than a loss in a circuit for charging the first battery, the charging efficiency can be further improved.

In the power supply system according to the present disclosure, the control device may be configured to charge the first battery and second battery by selecting a smaller loss between a loss at a time of performing series connection charge control and a loss at a time of performing the charge equalization control, the series connection charge control being control of charging the first battery and the second battery connected in series by the electric power from the power generation device or the external power supply by turning on and off the relays such that the first battery and the second battery are connected in series with respect to the power generation device or the external power supply. In this way, the first battery and the second battery can be charged more efficiently.

In the power supply system according to the present disclosure, the series-parallel switching circuit may include a series connection line configured to connect a negative electrode-side terminal of the first battery and a positive electrode-side terminal of the second battery, a series connection relay attached to the series connection line, a positive electrode bus connected to a positive electrode terminal of the first battery, a negative electrode bus connected to a negative electrode terminal of the second battery, an inverter connected to the positive electrode bus and the negative electrode bus, a three-phase alternating current motor driven by the inverter, a positive electrode-side relay attached to the positive electrode bus, a negative electrode-side relay attached to the negative electrode bus, a first parallel connection line configured to connect a first battery side and the negative electrode bus from the series connection relay of the series connection line, a first parallel connection relay attached to the first parallel connection line, a second parallel connection line configured to connect a positive electrode terminal of the second battery and a neutral point of the three-phase alternating current motor, and a second parallel connection relay and a third parallel connection relay attached to the second parallel connection line in an order of the second parallel connection relay and the third parallel connection relay from a second battery side, and the power generation device and the external power supply may be connected, via the power converter, to a power line including a charging relay, from the positive electrode-side relay of the positive electrode bus to the first battery side, and from the negative electrode-side relay of the negative electrode bus to the second battery side.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an outline of a configuration of a power supply system according to an embodiment of the present disclosure;

FIG. 2 is a flowchart showing an example of a charging process executed by the electronic control unit;

FIG. 3 is a flowchart showing an example of charge equalization control executed by the electronic control unit;

FIG. 4 is a descriptive view showing an example of a circuit during charging of solely the first battery;

FIG. 5 is a descriptive view showing an example of a circuit at the time of the equalization process; and

FIG. 6 is an explanatory diagram showing an example of a state of charging of the first battery and the second battery when the charge equalization control of the embodiment is performed and when the alternate charging control of the comparative example is performed.

### DETAILED DESCRIPTION OF EMBODIMENTS

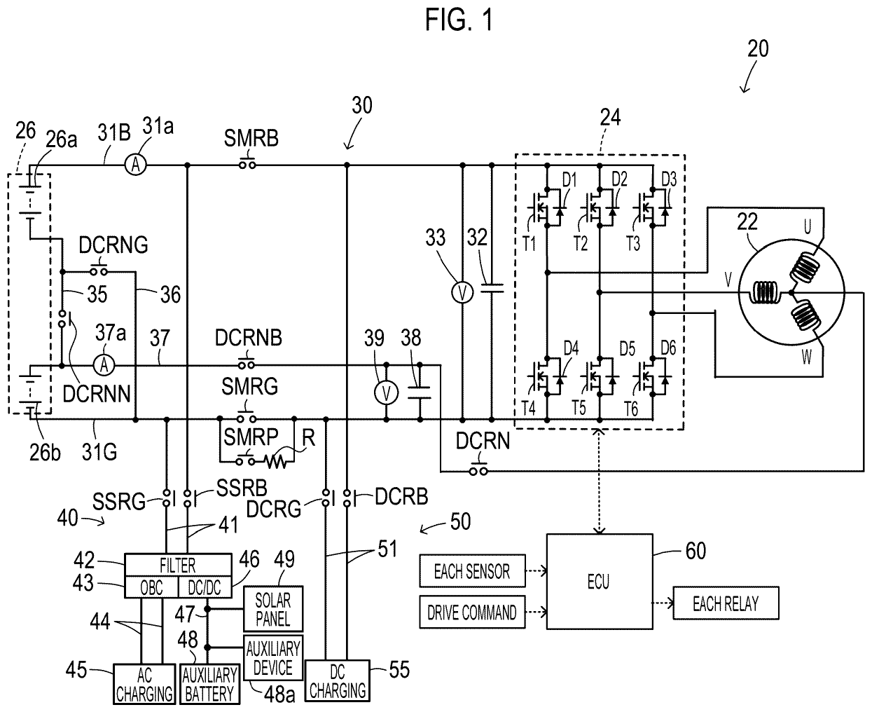

Next, an embodiment for implementing the present disclosure will be described. FIG. 1 is a configuration diagram showing an outline of a configuration of a power supply system 20 for a vehicle installation according to an embodiment of the present disclosure. The power supply system 20 of the embodiment is mounted on an electrified vehicle as a device that exchanges electric power between the battery 26 and the inverter 24 that drives the motor 22. The power supply system 20 charges or discharges the battery 26 by using the motor 22 and the inverter 24 as needed. The power supply system 20 includes a battery 26, a motor 22, an inverter 24, a power supply main circuit 30, an alternating current charging circuit 40, a direct current charging circuit 50, and an electronic control unit 60. The motor 22 functions as an electric motor for traveling of the electrified vehicle.

The motor 22 is configured as a well-known three-phase alternating current motor including, for example, a rotor to which a permanent magnet is attached on an outer surface and a stator wound with a three-phase coil. The inverter 24 is constituted of six transistors T1 to T6 as switching elements and six diodes D1 to D6 connected in parallel to the transistors T1 to T6 in a reverse direction. The transistors T1 to T6 are disposed in pairs such that the inverters 24 are on the source side and the drain side with respect to the positive electrode bus 31B and the negative electrode bus 31G of the battery 26. The transistors T1 to T6 are connected to each of connection points of the paired transistors, and each of the three-phase coils (U-phase, V-phase, W-phase) of the motor 22 is connected to the transistors. The inverter 24 forms a rotating magnetic field in the three-phase coil by controlling the proportion of the on-times of the transistors T1 to T6 constituting the pairs, in a state where a voltage is applied between the positive electrode bus 31B and the negative electrode bus 31G, and rotates and drives the motor 22. A first capacitor 32 for smoothing is attached between the positive electrode bus 31B and the negative electrode bus 31G.

The battery 26 has a first battery 26a and a second battery 26b having the same configuration as the first battery 26a. The first battery 26a and the second battery 26b are configured as, for example, a lithium ion secondary battery or a nickel-hydrogen secondary battery. A positive electrode terminal of the first battery 26a is connected to a positive electrode bus 31B, and a negative electrode terminal of the second battery 26b is connected to a negative electrode bus 31G. A negative electrode terminal of the first battery 26a is connected to a positive electrode terminal of the second battery 26b by a series power line 35 to which a relay DCRNN included in the configuration of the power supply main circuit 30 is attached. Therefore, the first battery 26a and the second battery 26b function as one battery connected in series by turning on the relay DCRNN.

The power supply main circuit 30 has a first parallel power line 36 and a second parallel power line 37 in addition to the positive electrode bus 31B, the negative electrode bus 31G, and the series power line 35. The first parallel power line 36 connects the negative electrode terminal of the first battery 26a and the negative electrode bus 31G. The second parallel power line 37 connects a positive electrode terminal of the second battery 26b to a neutral point of the motor 22. A positive electrode-side relay SMRB is attached to the positive electrode bus 31B, and a negative electrode-side relay SMRG is attached to the negative electrode bus 31G. In addition, a precharge circuit including a precharge relay SMRP and a resistor R is provided in parallel with the negative electrode-side relay SMRG on the negative electrode bus 31G. The positive electrode-side relay SMRB, the negative electrode-side relay SMRG, and the precharge circuit constitute a system main relay. That is, when the first battery 26a and the second battery 26b are connected in series, the positive electrode-side relay SMRB is turned on, and the precharge relay SMRP is turned on to charge the first capacitor 32. When the charging of the first capacitor 32 is completed, the negative electrode-side relay SMRG is turned on and the precharge relay SMP is turned off. As a result, the electric power from the battery 26 can be supplied to the inverter 24, or the battery 26 can be charged with the regenerative electric power by the motor 22. The battery 26 includes a first battery 26a and a second battery 26b connected in series.

The relay DCRNG is attached to the first parallel power line 36. The relay DCRNB is attached to the second battery 26b side of the second parallel power line 37, and the relay DCRN is attached to the neutral point side of the motor 22. The second capacitor 38 is attached between the relay DCRNB of the second parallel power line 37 and the relay DCRN, and between the negative electrode bus 31G.

The alternating current charging circuit 40 includes an alternating current charging power line 41 connected to the positive electrode bus 31B and the negative electrode bus 31G. The alternating current charging circuit 40 includes an onboard charger (OBC) 43 connected to an alternating current charging power line 41 via a filter 42. The alternating current charging circuit 40 includes an alternating current charging connector 45 connected to the onboard charger 43 via a power line 44. The alternating current charging circuit 40 includes a DC/DC converter 46 connected to the alternating current charging power line 41 via a filter 42 to be connected in parallel to the onboard charger 43. The alternating current charging circuit 40 includes an auxiliary battery or an auxiliary device 48a connected to the DC/DC converter 46 by a power line 47, and a solar panel 49. A relay SSRB is attached to a positive electrode side line of the alternating current charging power line 41, and a relay SSRG is attached to a negative electrode side line.

The direct current charging circuit 50 includes a direct current charging power line 51 connected to the positive electrode bus 31B and the negative electrode bus 31G, and a direct current charging connector 55 connected to the direct current charging power line 51. A relay DCRB is attached to a positive electrode side line of the direct current charging power line 51, and a relay DCRG is attached to a negative electrode side line.

The electronic control unit 60 is configured as a microcomputer centered on a CPU (not shown). The electronic control unit 60 is input with signals from various sensors. Examples of the various sensors include a voltage sensor 33 that detects a voltage VH between the terminals of the first capacitor 32 and a voltage sensor 39 that detects a voltage VD between the terminals of the second capacitor 38. Examples of the various sensors include a current sensor 31a that detects a current Ib1 flowing through the first battery 26a and a current sensor 37a that detects a current Id flowing through the second parallel power line 37. Examples of the various sensors include a phase current sensor (not shown) that detects phase currents Iu, Iv, and Iw flowing through the three phases of the motor 22. Examples of the various sensors include a voltage sensor (not shown) that detects a voltage Vb1 between terminals of the first battery 26a and a voltage sensor (not shown) that detects a voltage Vb2 between terminals of the second battery 26b. The electronic control unit 60 also functions as a control device that drives the motor 22, and thus also inputs a drive command or the like. When the power supply system 20 is mounted on the vehicle and the motor 22 is used as a motor for traveling, the accelerator operation amount or the vehicle speed may be input to the electronic control unit 60, and the electronic control unit 60 may generate a torque command of the motor 22.

The electronic control unit 60 outputs a drive control signal to each relay, a switching control signal to the inverter 24, and the like. Examples of the relay include a positive electrode-side relay SMRB, a negative electrode-side relay SMRG, a precharge relay SMRP, a relay DCRNN, a relay DCRNG, a relay DCRNB, and a relay DCRN. Examples of the relay include a relay SSRB, a relay SSRG, a relay DCRB, and a relay DCRG.

In the power supply system 20 according to the embodiment, in a case where the motor 22 is driven as a traveling motor and travels, the positive electrode-side relay SMRB, the negative electrode-side relay SMRG, the relay SSRB, the relay SSRG, and the relay DCRNN are turned on. Then, the relay DCRB, the relay DCRG, the relay DCRN, and the relay DCRB, the relay DCRG are turned off. Then, the six transistors T1 to T6 of the inverter 24 are switching-controlled by PWM control or the like based on the torque command corresponding to the accelerator operation amount or the vehicle speed V.

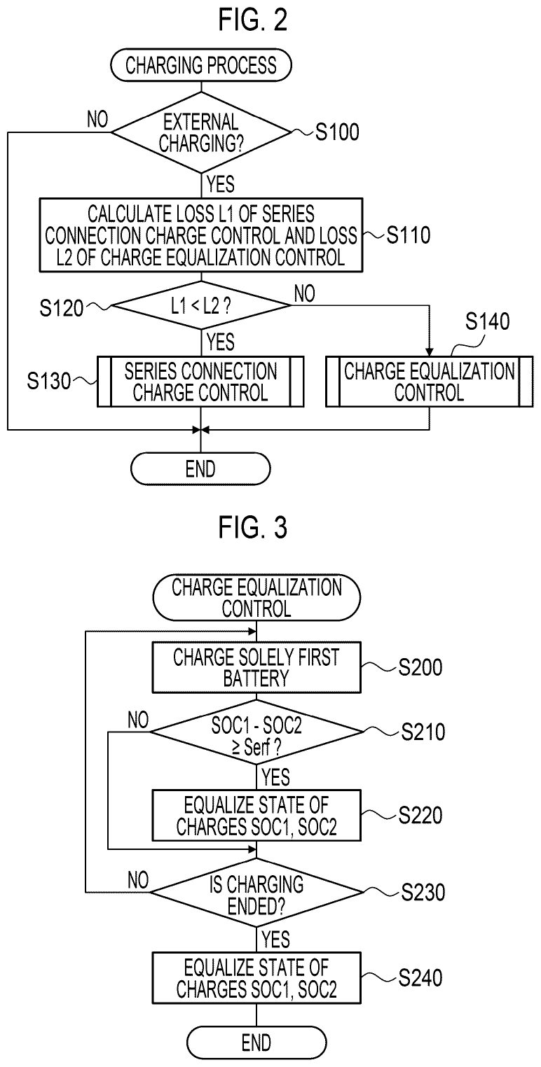

Next, an operation when the battery 26 is charged with electric power from the AC power source by connecting the AC power source to the alternating current charging connector 45 or when the battery 26 is charged with electric power generated by the solar panel 49 will be described. FIG. 2 is a flowchart showing an example of a charging process executed by the electronic control unit 60 when the battery 26 is charged with the power from the AC power source or the solar panel 49. FIG. 3 is a flowchart showing an example of the charge equalization control executed by the electronic control unit 60. The charge equalization control will be described later.

When the charging process is executed, the electronic control unit 60 determines whether the battery 26 is charged with the power from the AC power source or the solar panel 49 (S100). For example, in a case where the external direct current power supply is connected to the direct current charging connector 55 and the battery 26 is charged with the power from the external direct current power supply, the determination is made that the battery 26 is not charged with the power from the AC power supply or the solar panel 49. In this case, the process is not the target of the present process, and thus the process is terminated.

In S100, when determination is made that the charging of the battery 26 is performed by the power from the AC power source or the solar panel 49, the loss L1 when the series connection charge control is executed is calculated. The series connection charge control is a control of charging the first battery 26a and the second battery 26b connected in series. Then, the loss L2 when the charge equalization control is executed is calculated (S110). The charge equalization control alternately repeats the first battery charge process and the equalization process to charge the first battery 26a and the second battery 26b. The first battery charge process charges solely the first battery 26a. The equalization processing equalizes the state of charge SOC1 of the first battery 26a and the state of charge SOC2 of the second battery 26b. In the series connection charge control, the relay SSRB, the relay SSRG, and the relay DCRNN are turned on. Then, the positive electrode-side relay SMRB, the negative electrode-side relay SMRG, the relay DCRB, the relay DCRG, the relay DCRN, the relay DCRNB, the relay DCRB, and the relay DCRG are turned off. Then, the battery 26 is charged with the power from the AC power source or the solar panel 49. The loss L1 is a charging loss in the series connection charge control. The loss L1 is a loss of a circuit that extends from the filter 42 to the positive electrode bus 31B, the first battery 26a, the relay DCRNN, the second battery 26b, the negative electrode bus 31G, and the relay SSRG via the relay SSRB and returns to the filter 42. The charge equalization control and the loss L2 will be described below.

Next, the loss L1 when the series connection charge control is executed and the loss L2 when the charge equalization control is executed are compared (S120). When determination is made that the loss L1 when the series connection charge control is executed is smaller than the loss L2 when the charge equalization control is executed, the series connection charge control is executed (S130), and the present process is terminated. On the other hand, when the loss L1 when the series connection charge control is executed in S120 is equal to or greater than the loss L2 when the charge equalization control is executed, the charge equalization control is executed (S140), and the present process is terminated.

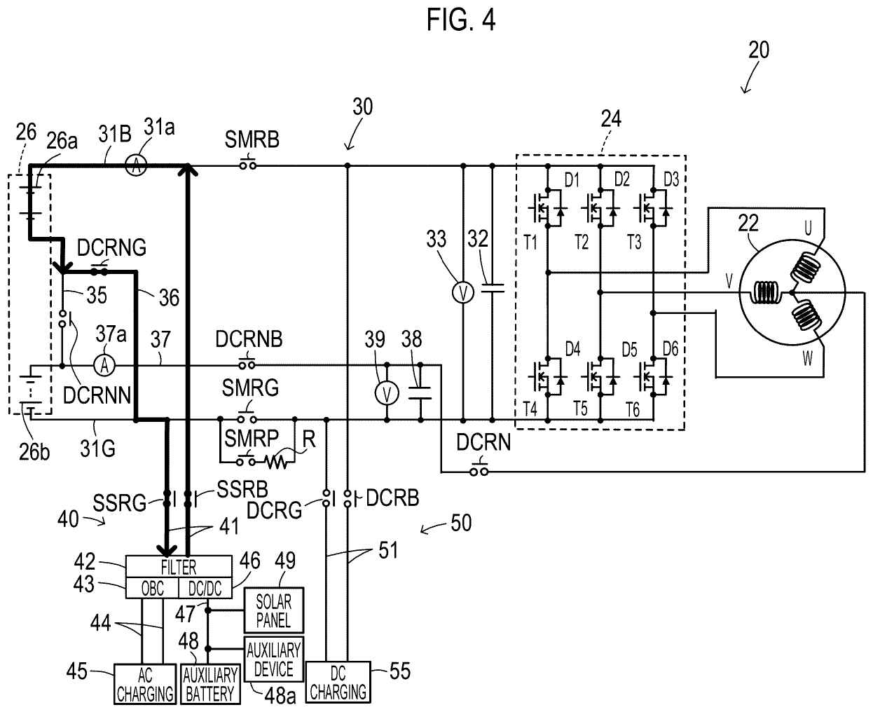

In the charge equalization control, as shown in the flowchart of FIG. 3, the electronic control unit 60 first charges solely the first battery 26a (S200). The sole charging of the first battery 26a is performed in a state where a relay SSRB, a relay SSRG, and a relay DCRNG are turned on as shown in the explanatory diagram of FIG. 4. Then, the positive electrode-side relay SMRB, the negative electrode-side relay SMRG, the relay DCRNN, the relay DCRB, the relay DCRG, the relay DCRN, the relay DCRNB, the relay DCRB, and the relay DCRG are turned off. Then, a circuit is provided from the filter 42, the positive electrode bus 31B, the first battery 26a, the relay DCRNG, the first parallel power line 36, the negative electrode bus 31G, and the relay SSRG which are connected to the filter 42 via the relay SSRB. In this way, solely the first battery 26a is charged.

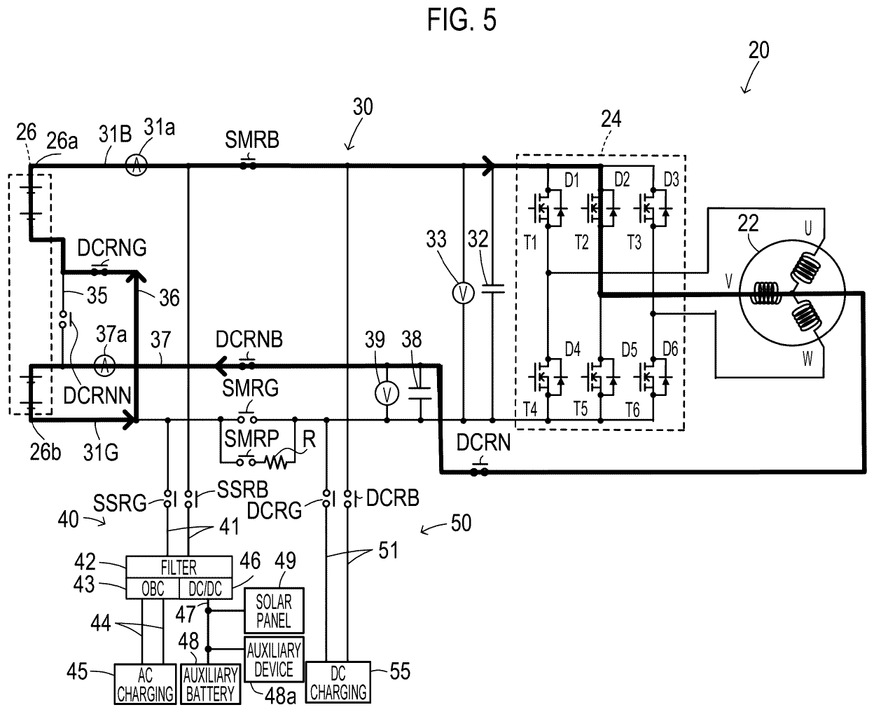

Next, determination is made as to whether a difference (SOC1-SOC2) between the state of charge SOC1 of the first battery 26a and the state of charge SOC2 of the second battery 26b is equal to or greater than a threshold value Sref (S210). When determination is made that the difference (SOC1-SOC2) between the state of charge SOC1 of the first battery 26a and the state of charge SOC2 of the second battery 26b is equal to or greater than a threshold value Sref, the following processing is performed. The process of equalizing the state of charge SOC1 of the first battery 26a and the state of charge SOC2 of the second battery 26b is performed (S220). As shown in the schematic diagram of FIG. 5, the equalization process turns on the positive electrode-side relay SMRB, the relay DCRNG, the relay DCRN, and the relay DCRNB. Then, the relay SSRB, the relay SSRG, the positive electrode-side relay SMRB, the negative electrode-side relay SMRG, the relay DCRNN, the relay DCRB, and the relay DCRG are turned off. Further, any one or two or all of the transistors T1, T2, T3 of the inverter 24 are turned on. Then, a circuit is provided from the positive electrode terminal of the first battery 26a to the positive electrode bus 31B, the positive electrode-side relay SMRB, the transistors T1, T2, T3 of the inverter 24, the motor 22, the second parallel power line 37, the relay DCRN, the relay DCRNB, the second battery 26b, the negative electrode bus 31G, the first parallel power line 36, and the relay DCRNG to the negative electrode terminal of the first battery 26a. The equalization process is performed in this way. When determination is made in S210 that the difference (SOC1 SOC2) between the state of charge SOC1 of the first battery 26a and the state of charge SOC2 of the second battery 26b is less than the threshold value Sref, the equalization process is not performed.

Next, determination is made as to whether the battery 26 is charged (S230). The end of the charging of the battery 26 includes a case where the first battery 26a and the second battery 26b are fully charged or a case where the preparation for starting traveling is performed. When the determination is made that the charging of the battery 26 is not terminated, the process returns to the process of charging solely the first battery 26a of S200. The processes of S200 to S230 include a process of charging solely the first battery 26a, and a process of equalizing the state of charge SOC1 of the first battery 26a and the state of charge SOC2 of the second battery 26b, and are alternately repeated until the charging end is determined. The process of charging solely the first battery 26a is performed until a difference between the state of charge SOC1 of the first battery 26a and the state of charge SOC2 of the second battery 26b is equal to or greater than a threshold value Sref. The loss L2 of the charge equalization control is a loss when a process of charging solely the first battery 26a and a process of equalizing the state of charge SOC1 of the first battery 26a and the state of charge SOC2 of the second battery 26b are alternately performed.

When determination is made in S230 that the charging is terminated, the equalization process is performed (S240), and the present process is terminated. The equalization processing is performed last in order to make the state of charge SOC1 of the first battery 26a and the state of charge SOC2 of the second battery 26b the same.

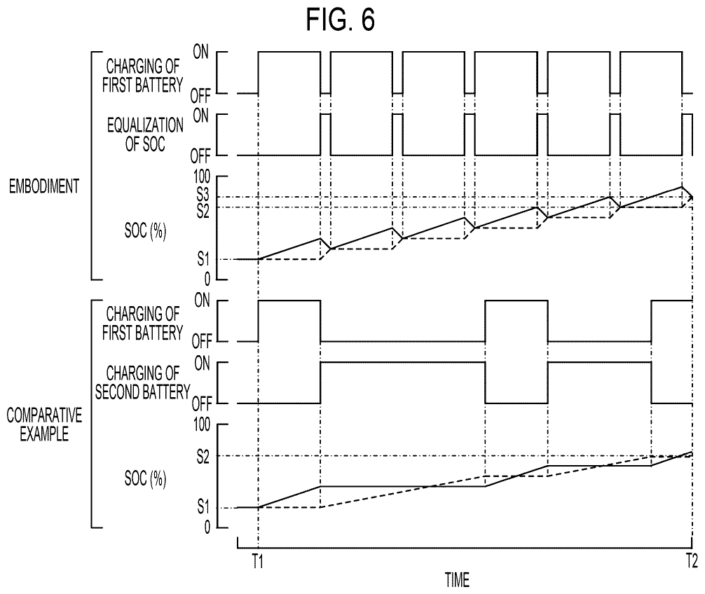

FIG. 6 is a descriptive view showing an example of a state of charging of the first battery 26a and the second battery 26b when the charge equalization control of the embodiment is performed and when the alternate charging control of the comparative example is performed. In the figure, in the state of charge SOC, a solid line indicates a state of charge SOC1 of the first battery 26a, and a broken line indicates a state of charge SOC2 of the second battery 26b. The alternate-current charging control of the comparative example alternately charges solely the first battery 26a and solely the second battery 26b. Charging of solely the second battery 26b is performed in a state in which the relay SSRB, the relay SSRG, the positive electrode-side relay SMRB, the relay DCRN, and the relay DCRNB are turned on. Then, the negative electrode-side relay SMRG, the relay DCRNG, the relay DCRNN, the relay DCRB, and the relay DCRG are turned off. Further, any one or two or all of the transistors T1, T2, T3 of the inverter 24 are turned on. Then, a circuit is provided from the filter 42, the positive electrode bus 31B, the positive electrode-side relay SMRB, the transistors T1, T2, T3 of the inverter 24, the motor 22, the second parallel power line 37, the relay DCRN, the relay DCRNB, the second battery 26b, the negative electrode bus 31G, and the relay SSRG which are connected to the filter 42 via the relay SSRB. The charging of solely the second battery 26b is performed in this way. In the alternate-current charging control of the comparative example, the charging of solely the second battery 26b is performed through the transistors T1, T2, T3 of the inverter 24 or the motor 22, and thus a loss is increased. Therefore, the charging of solely the second battery 26b takes a longer time to charge as compared with the charging of solely the first battery 26a, and the charging efficiency is reduced. Therefore, when the state of charge SOC of the battery 26 starts to be charged at time T1 of the value S1 and ends charging at time T2, the state of charge SOC of the battery 26 becomes the value S2. On the other hand, in the charge equalization control of the embodiment, the transistors T1, T2, T3 of the inverter 24 and the motor 22 are used in the same manner as the charging of solely the second battery 26b in the equalization process. Therefore, the loss is large, but since the equalization processing is completed in a short time, the loss is small as a whole. Charging of solely the first battery 26a having a high charging efficiency is mainly performed, and when the state of charge SOC of the battery 26 starts charging at time T1 of the value S1 and ends charging at time T2, the state of charge SOC of the battery 26 is a value S3 greater than the value S2 of the comparative example.

In the power supply system 20 of the embodiment, the following process is performed when the battery 26 is charged with the power from the AC power supply or the solar panel 49. That is, when the loss L1 when the series connection charge control is executed is equal to or greater than the loss L2 when the charge equalization control is executed, the charge equalization control is executed to charge the battery 26. Therefore, the charging time can be shortened and the charging efficiency can be improved as compared with a case where the battery 26 is charged by executing the alternate charging control for alternately performing the charging of solely the first battery 26a and the charging of solely the second battery 26b.

In the power supply system 20 of the embodiment, the following process is performed when the battery 26 is charged with the power from the AC power supply or the solar panel 49. That is, the battery 26 is charged by selecting a smaller one of the loss L1 when the series connection charge control is executed and the loss L2 when the charge equalization control is executed. As a result, the charging efficiency can be further improved.

The correspondence between the main elements of the embodiment and the main elements of the disclosure described in the column of the means for solving the problems will be described. In the embodiment, the first battery 26a is an example of a “first battery”. The second battery 26b is an example of a “second battery”. The solar panel 49 is an example of a “power generation device”. The onboard charger 43 and the DC/DC converter 46 are examples of the “voltage converter”. The power supply main circuit 30 is an example of a “series-parallel switching circuit”. The electronic control unit 60 is an example of a “control device”. The power supply system 20 is an example of a “power supply system”.

The correspondence between the main elements of the embodiment and the main elements of the disclosure described in the column of means for solving the problem is an example for specifically describing the embodiment for implementing the disclosure described in the column of means for solving the problem. These are not intended to limit the elements of the disclosure described in the column of the means for solving the problem. That is, the interpretation of the disclosure described in the column of the means for solving the problem should be made based on the description in the column, and the embodiment is merely a specific example of the disclosure described in the column of the means for solving the problem.

Although the embodiment for implementing the above-described disclosure has been described, the above-described disclosure is not limited to the embodiment, and can be implemented in various forms within the scope of the spirit of the above-described disclosure.

The present disclosure can be used in a manufacturing industry of a power supply system or the like.

What is claimed is:

1. A power supply system for a vehicle installation comprising:
a first battery;
a second battery having the same configuration as the first battery;
a power converter connected to either or both of a power generation device installed in a vehicle and an external power supply;
a series-parallel switching circuit including a plurality of relays and being switchable between a series connection of the first battery and the second battery and a parallel connection of the first battery and the second battery by turning on and off the relays; and
a control device configured to control and drive the relays of the series-parallel switching circuit,
wherein the control device performs, when the first battery and the second battery are charged by electric power from the power generation device or the external power supply, charge equalization control of alternately performing, a first battery charge process of charging solely the first battery by turning on and off the relays such that solely the first battery is charged by the electric power from the power generation device or the external power supply, and a state-of-charge equalization process of equalizing a state of charge of the first battery and a state of charge of the second battery by charging the second battery by electric power from the first battery by turning on and off the relays such that the second battery is charged by the electric power from the first battery.

2. The power supply system according to claim 1, wherein the control device is configured to charge the first battery and second battery by selecting a smaller loss between a loss at a time of performing series connection charge control and a loss at a time of performing the charge equalization control, the series connection charge control being control of charging the first battery and the second battery connected in series by the electric power from the power generation device or the external power supply by turning on and off the relays such that the first battery and the second battery are connected in series with respect to the power generation device or the external power supply.

3. The power supply system according to claim 1, wherein:
the series-parallel switching circuit includes a series connection line configured to connect a negative electrode-side terminal of the first battery and a positive electrode-side terminal of the second battery, a series connection relay attached to the series connection line, a positive electrode bus connected to a positive electrode terminal of the first battery, a negative electrode bus connected to a negative electrode terminal of the second battery, an inverter connected to the positive electrode bus and the negative electrode bus, a three-phase alternating current motor driven by the inverter, a positive electrode-side relay attached to the positive electrode bus, a negative electrode-side relay attached to the negative electrode bus, a first parallel connection line configured to connect a first battery side and the negative electrode bus from the series connection relay of the series connection line, a first parallel connection relay attached to the first parallel connection line, a second parallel connection line configured to connect a positive electrode terminal of the second battery and a neutral point of the three-phase alternating current motor, and a second parallel connection relay and a third parallel connection relay attached to the second parallel connection line in an order of the second parallel connection relay and the third parallel connection relay from a second battery side; and
the power generation device and the external power supply are connected, via the power converter, to a power line including a charging relay, from the positive electrode-side relay of the positive electrode bus to the first battery side, and from the negative electrode-side relay of the negative electrode bus to the second battery side.
